(19) United States
(12) Patent Application Publication
(10) Pub. No.: US 2017/0299867 A1
(43) Pub. Date: Oct. 19, 2017

(54) HEAD-MOUNTED DISPLAY APPARATUS

(71) Applicant: Coretronic Corporation, Hsin-Chu (TW)

(72) Inventors: Chih-Hsien Tsai, Hsin-Chu (TW); Jo-Han Hsu, Hsin-Chu (TW); Yi-Hsuang Weng, Hsin-Chu (TW)

(73) Assignee: Coretronic Corporation, Hsin-Chu (TW)

(21) Appl. No.: 15/486,307

(22) Filed: Apr. 13, 2017

(30) Foreign Application Priority Data
Apr. 15, 2016 (TW) 105111739

(51) Int. Cl. G02B 27/01; F21V 8/00

(52) U.S. Cl. CPC G02B 27/0172; G02B 27/0179; G02B 6/0005; G02B 2027/0185; G02B 2027/0178

(57) ABSTRACT

A head-mounted display apparatus projected an image onto a projection target is provided. The head-mounted display apparatus includes an image output module, an image control module, an optical fiber, and an optical adjusting device. The image output module projects the image onto the projection target. The image control module outputs a lighting beam and an electrical signal to the image output module, so as to control the image output module to project the image onto the projection target by using the electrical signal. The optical fiber is coupled to the image output module and the image control module. The lighting beam is transmitted from the image control module to the image output module via the optical fiber. The optical adjusting device is disposed at the output terminal of the optical fiber and transmits the lighting beam to the image output module.

### CROSS-REFERENCE TO RELATED APPLICATION

This application claims the priority benefit of Taiwan application serial no. 105111739, filed on Apr. 15, 2016. The entirety of the above-mentioned patent application is hereby incorporated by reference herein and made a part of this specification.

### BACKGROUND OF THE INVENTION

### Field of the Invention

The invention relates to a display apparatus, and more particularly, to a head-mounted display apparatus adapted to project an image frame.

### Description of Related Art

In relevant techniques, a plurality of user-wearable display apparatuses exists. In general, such the apparatus generally projects an image onto the human eye via an optical system by using a liquid crystal display (LCD) or an organic light-emitting diode (OLED) to allow the user (viewer) to view the image. However, such the apparatus is typically not light in weight due to limitations in the size of the display screen thereof, and is therefore inconvenient to wear. Therefore, to achieve the feature of lightweight, a current solution is the use of a virtual retinal display (VRD) technique. The VRD technique is a display technique that directly images light signal via the retina of the human eye. However, such a display technique has the same issue when applied in many other wearable display apparatuses, that is, the image distance perceived by the human eye is fixed. Specifically, when the human eye is looking near and far, the lens is automatically adjusted to different thicknesses to change the focal length. However, in current relevant display techniques, such an effect cannot be achieved, such that the perception of the human eye for accommodation and convergence when viewing an image is inconsistent, and as a result discomfort such as dizziness or nausea often occurs during viewing.

In current techniques, other optical systems may be added to the head-mounted display apparatus to improve the above drawbacks. However, the head-mounted display apparatus becomes too complex as a result, and is therefore not suitable for wearing.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The invention provides a head-mounted display apparatus having a simple design, is convenient to wear, and may project an image onto a projection target and provide good display quality.

Other objects and advantages of the invention can be further understood from the technical features disclosed in the invention.

To achieve one or some or all of the above objects or other objects, an embodiment of the invention provides a head-mounted display apparatus adapted to project an image onto a projection target. The head-mounted display apparatus includes an image output module, an image control module, an optical fiber, and an optical adjusting device. The image output module is adapted to project the image onto the projection target. The image control module is electrically connected to the image output module and adapted to output a first electrical signal to the image output module, so as to control the image output module to project the image onto the projection target by using the first electrical signal. The image control module outputs a lighting beam to the image output module. The optical fiber is adapted to be optically coupled to the image output module and the image control module. The lighting beam is transmitted to the image output module from the image control module via the optical fiber. The optical adjusting device is disposed at the output terminal of the optical fiber and adapted to transmit the lighting beam to the image output module.

In an embodiment of the invention, the optical adjusting device outputs the lighting beam to the image output module in a collimated manner.

In an embodiment of the invention, the optical adjusting device adjusts the focus position of the image according to a second electrical signal.

In an embodiment of the invention, the optical fiber is extended in a preset direction in a straight line, so as to be connected to the image output module and the image control module.

In an embodiment of the invention, the optical fiber is extended in a plurality of different directions in a curved line, so as to be connected to the image output module and the image control module.

In an embodiment of the invention, the image control module includes a light source module and an image information output device. The light source module is adapted to output the lighting beam to the optical fiber. The lighting beam is transmitted from the light source module to the image output module via the optical fiber. The image information output device is adapted to control the light source module to output the lighting beam and output the first electrical signal to control the image output module to project the image onto the projection target.

In an embodiment of the invention, the lighting beam outputted by the light source module is monochromatic light or a colored light including a plurality of colors.

In an embodiment of the invention, the image output module includes an optical modulator and a projection device. The optical modulator is adapted to receive the lighting beam transmitted by the optical adjusting device and modulate the lighting beam according to the first electrical signal to generate the image frame. The projection device is adapted to project the image onto the projection target.

In an embodiment of the invention, the head-mounted display apparatus further includes an apparatus body. The apparatus body is adapted to carry the image output module, the image control module, the optical fiber, and the optical adjusting device. The image output module, the image control module, the optical fiber, and the optical adjusting device are disposed on the apparatus body in an embedded manner or by hanging externally.

In an embodiment of the invention, the image is a two-dimensional image or a three-dimensional image after imaging.

Based on the above, the embodiments of the invention have at least one of the following advantages or efficacies. In an exemplary embodiment of the invention, the image control module and the image output module are connected by an optical fiber, and an optical adjusting device is disposed at the output terminal of the optical fiber. Therefore, the head-mounted display apparatus of an embodiment of the invention has a simple design, is convenient to wear, and can provide good display quality.

Several exemplary embodiments accompanied with figures are described in detail below to further describe the disclosure in details.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a schematic block diagram of a head-mounted display apparatus of an embodiment of the invention.

FIG. 2 shows a schematic diagram of the output of a lighting beam to an image output module of an embodiment of the invention.

FIG. 3 shows a schematic diagram of a head-mounted display apparatus of an embodiment of the invention.

FIG. 4A to FIG. 4C show schematic diagrams of an optical adjusting device adjusting the focus position of an image of an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The above and other technical content, features, and efficacies of the invention are illustrated in the following via the detailed description of a preferred embodiment of the reference figures. Terms used to describe direction in the following embodiments such as up, down, left, right, front, or back are only the directions of reference figures. Thus, terms used to describe directions are descriptive and are not intended to limit the scope of the invention.

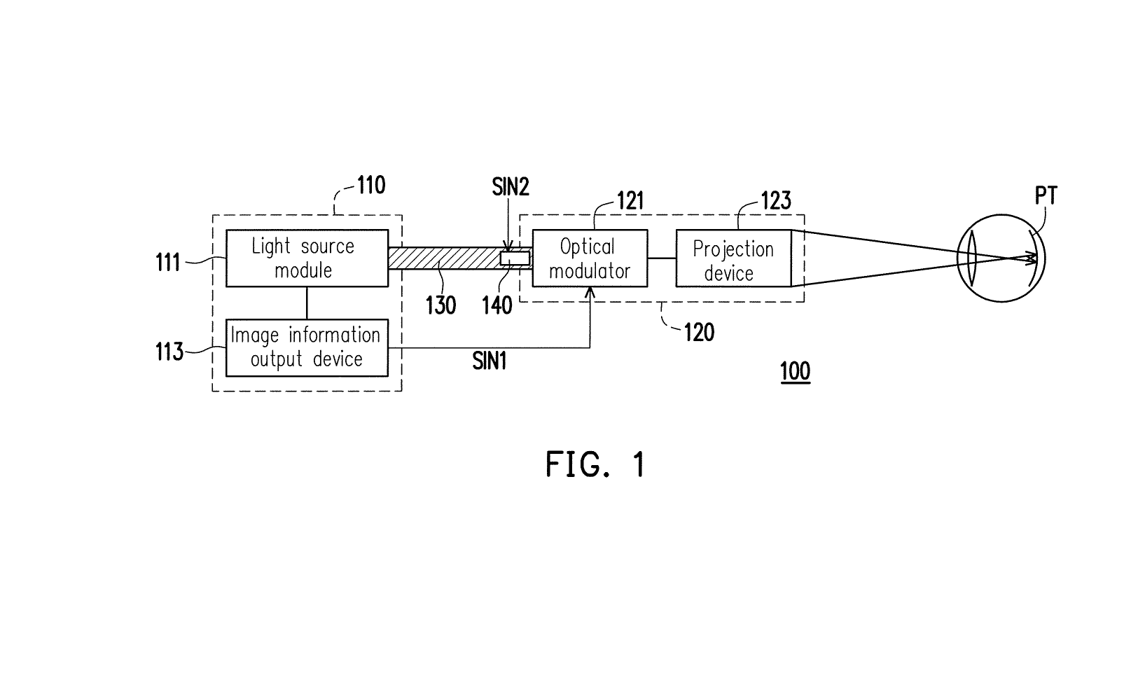

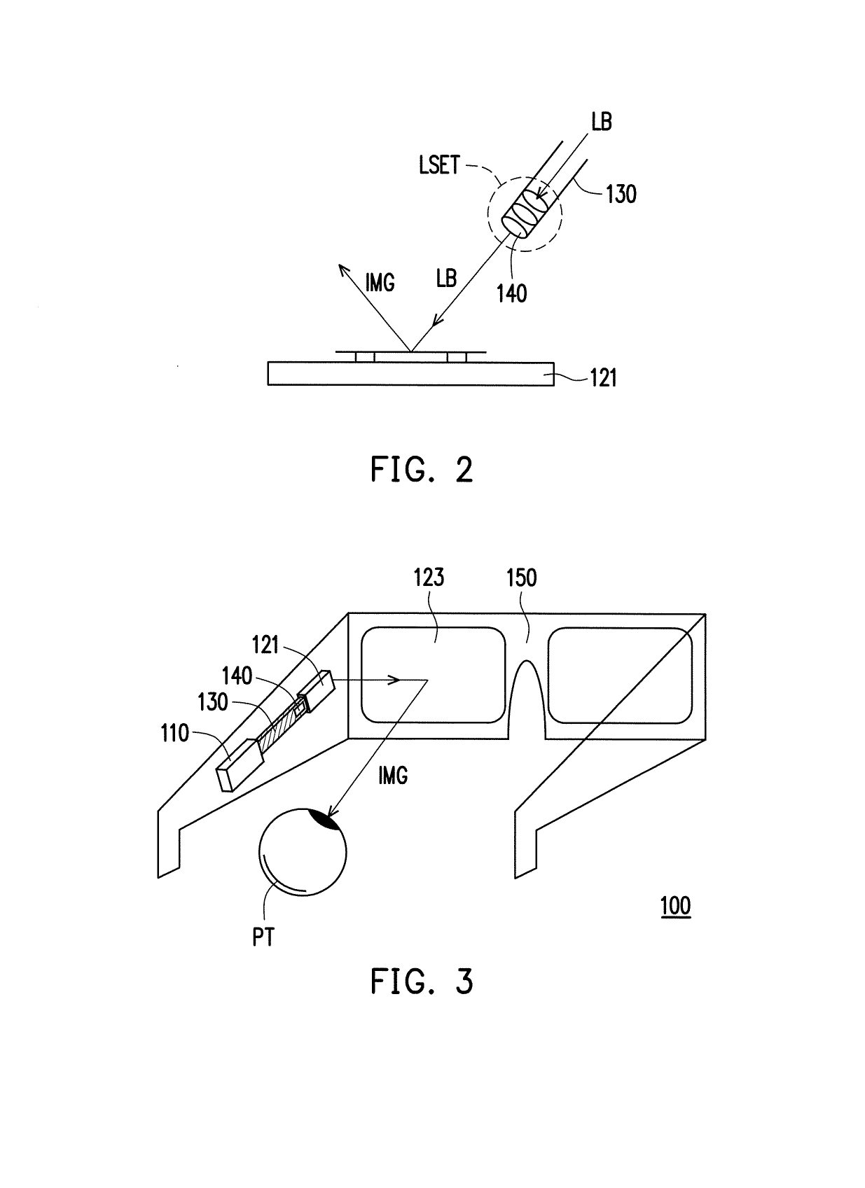

FIG. 1 shows a schematic block diagram of a head-mounted display apparatus of an embodiment of the invention. FIG. 2 shows a schematic diagram of the output of a lighting beam to an image output module of an embodiment of the invention. FIG. 3 shows a schematic diagram of a head-mounted display apparatus of an embodiment of the invention. Referring to FIG. 1 to FIG. 3, a head-mounted display apparatus 100 of the embodiment includes an image control module 110, an image output module 120, an optical fiber 130, and an optical adjusting device 140. The image control module 110 includes a light source module 111 and an image information output device 113. The image output module 120 includes an optical modulator 121 and a projection device 123. In the embodiment, the optical fiber 130 is connected to the light source module 111 of the image control module 110 and the optical modulator 121 of the image output module 120, and an optical adjusting device 140 is disposed at the output terminal of the optical fiber 130. In the head-mounted display apparatus 100 of the embodiment, the image control module 110 outputs a lighting beam LB and provides an electrical signal SIN1 to the image output module 120, the optical modulator 121 of the image output module 120 is controlled by the electrical signal SIN1, and an image IMG modulated by the optical modulator 121 according to the electrical signal SIN1 is projected onto a projection target PT.

In the embodiment, the light source module 111 is adapted to output the lighting beam LB, and the lighting beam LB is transmitted to the optical modulator 121 via the optical fiber 130. The lighting beam LB is, for instance, monochromatic light such as red light, green light, or blue light having wavelength ranges or white light combined from a plurality of colors or other colored lights, and the invention is not limited thereto. In an embodiment, the light source module 111 further includes a light intensity modulator (for example, light controlling circuitry), and is adapted to, for instance, provide a light source control electrical signal corresponding to the electrical signal SIN1 outputted from the image information output device 113 to modulate the light intensity of the lighting beam LB. However, the form of the light source and the wavelength range and the light intensity of the lighting beam LB are not intended to limit the invention, wherein the light source used in the light source module 111 is, for instance, a light-emitting diode (LED), laser diode (LD) or an organic light-emitting diode (OLED), and any light source satisfying size requirements in actual design can be used, and is not limited thereto.

In the embodiment, the lighting beam LB outputted by the light source module 111 is transmitted to the optical modulator 121 via the optical fiber 130. At the output terminal of the optical fiber 130, the optical adjusting device 140 is disposed in the transmission path of the lighting beam LB between the light source module 111 and the optical modulator 121. In the embodiment, the optical adjusting device 140 is, for instance, a zooming liquid lens formed by optical liquid crystal and a polymer film that can change the shape thereof, such that different focal lengths can be generated and the effect of rapid focal change can be achieved. Alternatively, a liquid crystal lens (LC-lens) is used, and the voltage value is modulated and the index of refraction of the liquid crystal lens is changed by using the birefringence properties of the liquid crystal material and the property that the liquid crystal molecules are arranged with the electric field direction, so as to modulate the effective focal length of the optical adjusting device 140, and the function of zooming is achieved as a result. In another embodiment, the optical adjusting device 140 is, for instance, a lens device capable of modulating the focal length such as an electrowetting lens (EW-lens), a liquid-filled membrane lens, or a dielectric liquid lens, and the invention is not limited thereto.

In the embodiment, the optical adjusting device 140 can focus or diverge the lighting beam LB according to the electrical signal SIN2 provided by the image information output device 113 so as to change the focus position of the image IMG beforehand. In an embodiment, the electrical signal SIN2, for instance, externally inputs from human interface device (HID), touch panel, etc., for controlling the optical adjusting device 140, and the invention does not limit the electrical signal SIN2 and the source thereof.

Moreover, in an embodiment, as shown in FIG. 2, one or a plurality of lenses is further disposed in the transmission path of the lighting beam LB between the light source module 111 and the optical modulator 121. One or a plurality of lenses may be a lens set LSET within the optical adjusting device 140, so as to focus or diverge the lighting beam LB and transmit the lighting beam LB to the optical modulator 121. In the embodiment, the lens set LSET is formed by the optical adjusting device 140 itself or by combining the optical adjusting device 140 with one or a plurality of other lenses, and regarding the method in which the lighting beam LB is focused or diverged according to the electrical signal SIN2, those having ordinary skill in the art can obtain sufficient teaching, suggestion, and implementation instructions for the detailed steps and implementation thereof, and therefore the detailed steps and implementation thereof are not repeated herein.

In the embodiment, the optical modulator 121 is disposed near the output terminal of the optical fiber 130, and is adapted to receive the lighting beam LB transmitted from the optical adjusting device 140 and modulate the lighting beam LB according to the electrical signal SIN1. In the embodiment, the optical modulator 121 is, for instance, a digital micromirror device controlled by the electrical signal SIN1. The optical modulator 121 converts the lighting beam LB into the image IMG according to the image information contained in the electrical signal SIN1, and, for instance, transmits the image IMG to the projection device 123 by reflection.

In an embodiment, the optical modulator 121 can be, for instance, a reflective optical modulator such as a liquid crystal on silicon panel (LCoS panel) or a digital micro-mirror device (DMD), or a transmissive optical modulator such as a transparent liquid crystal panel, an electro-optical modulator, a maganeto-optic modulator, or an acousto-optic modulator (AOM) according to different relative positions of the optical fiber 130, the optical modulator 121, and the projection device 123. However, the invention does not limit the configuration and the type of the optical modulator 121. In the embodiment, the optical modulator 121 converts the lighting beam LB into the image IMG, those having ordinary skill in the art can obtain sufficient teaching, suggestion, and implementation instructions for the detailed steps and implementation thereof, and therefore the detailed steps and implementation thereof are not repeated herein.

In the embodiment, the projection device 123 is adapted to project the image MG transmitted by the optical modulator 121 onto the projection target PT in a reflection. The projection device 123 includes, for instance, a projection lens, and the projection lens includes a combination of one or a plurality of non-planar optical lenses having diopter, and includes, for instance, various combinations of non-planar lenses such as a biconcave lens, a lenticular lens, a meniscus lens, a convex and concave lens, a plano-convex lens, or a plano-concave lens. In an embodiment, the projection device 123 can also be a planar optical lens, and the image IMG is projected onto the projection target PT in a reflective or transmissive manner. The invention does not limit the configuration and the type of the projection device 123.

In the embodiment, the projection target PT is, for instance, the eye of the user, and the projection device 123 projects the image IMG converted by the optical modulator 121 onto the retina of the eye of the user for imaging. In an embodiment, the projection target PT can also be an image capture or recording apparatus, and includes, for instance, a similar apparatus such as a charge-coupled device image sensor (CCD image sensor) or a complementary metal oxide semiconductor (CMOS) image sensor, and the invention is not limited thereto.

In the embodiment, the image information output device 113, for instance, respectively connects and outputs the light source control electrical signal corresponding to the electrical signal SIN1 to the light source module 111 and outputs the electrical signal SIN1 to the optical modulator 121. The electrical signal SIN1 carries image information. The light source module 111 controls a parameter such as the wavelength, the light intensity, or the phase of the outputted lighting beam LB according to the light source control electrical signal corresponding to the electrical signal SIN1. The optical modulator 121 converts the lighting beam LB into the image IMG according to the electrical signal SIN1. In other words, the head-mounted display apparatus 100 of the embodiment outputs the electrical signal via the image information output device 113 to control the optical modulator 121 and project the content of the image IMG onto the projection target PT.

In an embodiment, the image information output device 113, for instance, further connects and outputs the electrical signal SIN2 to the optical adjusting device 140. The optical adjusting device 140 focuses or diverges the lighting beam LB according to the electrical signal SIN2 so as to change the focus position of the image IMG. The image information output device 113 has the function of receiving an image signal and perform corresponding signal processing to generate the electrical signal SIN1, the electrical signal SIN2, and a light source electrical signal corresponding to the electrical signal SIN1. For instance, a central processing unit (CPU), a microprocessor, a digital signal processor (DSP), a programmable controller, a programmable logic device (PLD), or other similar apparatuses or a combination of the apparatuses can be included, and the invention is not limited thereto. Moreover, in an embodiment, each operating function of the image information output device 113 can be used as a plurality of program codes. The program codes are stored in one memory (not shown), and the program codes are executed by the processing circuit or the control circuit of the image information output device 113. The invention does not limit whether each operating function of the image information output device 113 is implemented in software or hardware form.

Referring to FIG. 3, the head-mounted display apparatus 100 of the embodiment further includes an apparatus body 150, and devices such as the image control module 110, the optical modulator 121, the optical fiber 130, and the optical adjusting device 140 are embedded to the apparatus body 150. In the embodiment, the apparatus body 150 is, for instance, an eyewear. The projection device 123 is, for instance, one of the lenses of the eyewear, and the image control module 110 and the optical modulator 121 are embedded in one of the feet of the eyewear. The optical fiber 130 is extended in a direction from the image control module 110 to the optical modulator 121 in a straight line to be connected to the image output module 120, and the optical adjusting device 140 disposed at the output terminal of the optical fiber 130 adjusts the lighting beam LB outputted by the light source module 111 to a parallel light and outputs the lighting beam LB to the optical modulator 121 in a collimated manner. The image IMG generated by the optical modulator 121 is projected onto the eye of the user via a lens. In other embodiments, the optical fiber 130 can also be, for instance, extended from the image control module 110 in a plurality of different directions in a curved line and connected to the optical modulator 121.

In addition to the above embedding method, in another embodiment, devices such as the image control module 110, the image output module 120, the optical fiber 130, and the optical adjusting device 140 of the head-mounted display apparatus 100 can also be, for instance, disposed on the apparatus body 150 by hanging externally, or disposed on the apparatus body 150 by, for instance, embedding some of the devices and hanging the other devices externally, and the invention does not limit the configuration of the head-mounted display apparatus 100.

In an embodiment, the apparatus body 150 is, for instance, an eyewear, and the projection device 123 includes, for instance, two lenses of the eyewear. However, in the embodiment, the optical modulator 121 is not disposed in the same foot as the image control module 110, and can be, for instance, disposed in the frame or another foot of the eyewear, or other locations of the eyewear. The optical fiber is connected to the optical modulator 121 via the image control module 110 in a curved line along the eyewear, and the optical adjusting device 140 disposed at the output terminal of the optical fiber 130 outputs the lighting beam LB outputted by the light source module 111 to the optical modulator 121 according to the electrical signal SIN2 after adjustment. The image IMG generated by the optical modulator 121 is respectively projected onto both eyes of the user via the two lenses of the eyewear. When the image IMG is a two-dimensional image, the images generated by the optical modulator 121 and projected onto the retinas of both eyes of the user are, for instance, the same two images; when the image IMG is a three-dimensional image, the images generated by the optical modulator 121 and projected onto the retinas of both eyes of the user are, for instance, two different parallactic images. In an embodiment, when the image IMG is a three-dimensional image, the optical adjusting device 140 can, for instance, correspondingly adjust the lighting beam LB according to the content of the image IMG.

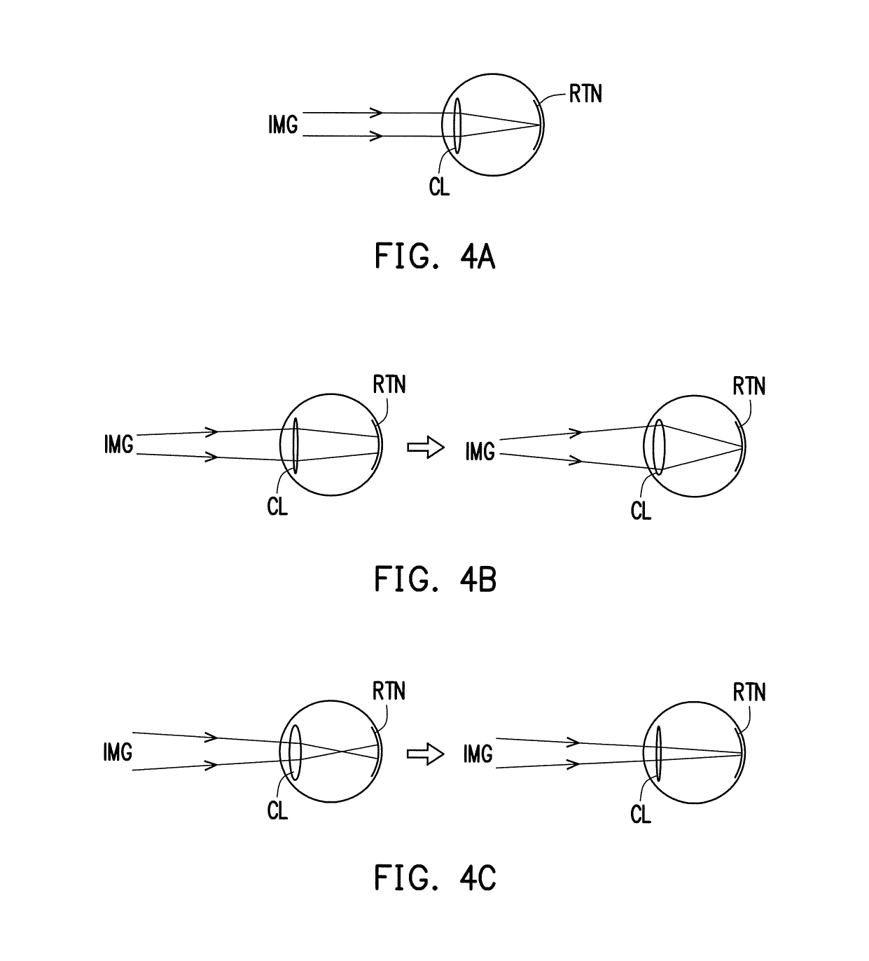

FIG. 4A to FIG. 4C show schematic diagrams of an optical adjusting device adjusting the focus position of an image of an embodiment of the invention. In general, as shown in FIG. 4A, when the image light of an object enters the eye, the image light of the object is focused on a retina RTN via a lens CL. In terms of a display apparatus viewed with both eyes, in the embodiment, the image IMG is a three-dimensional image, and the optical modulator 121 generates two different parallactic images to be projected onto the retinas RTN of both eyes of the user according to the electrical signal SIN1, and the optical adjusting device 140 adjusts the focus position of the imaging screen IMG according to the electrical signal SIN2. For instance, as shown in FIG. 4B, the smaller the parallax generated by the optical modulator 121 according to the electrical signal SIN1, the longer the focal length is adjusted by the optical adjusting device 140 according to the electrical signal SIN2, and therefore the lens needs to correspondingly adjust the focal length shorter so as to allow the image IMG to be focused on the retina RTN. On the other hand, as shown in FIG. 4C, the greater the parallax of the optical modulator 121 according to the electrical signal SIN1, the shorter the focal length is adjusted by the optical adjusting device 140 according to the electrical signal SIN2, and therefore the lens needs to correspondingly adjust the focal length longer so as to allow the image IMG to be focused on the retina RTN. As a result, in the embodiment, the ciliary muscle of the user is relaxed or contracted in response to the parallax of both eyes, so as to correspondingly adjust the thickness of the lens CL to allow the image IMG to be focused on the retina RTN.

In an embodiment, the three-dimensional image IMG can also be, for instance, implemented in a display apparatus viewed with a single eye via the optical modulator 121 having an amplitude and phase modulation capability by using a technical means such as a computer hologram, such that the image IMG is made into a three-dimensional image. For instance, a holographic image corresponding to the three-dimensional image is calculated via the image information output device 113, and the holographic image can generate the virtual image to be displayed in a preset direction and a preset location via the optical modulator 121 having an amplitude or phase modulation capability and suitable beam conditions such as wavelength and wavefront, and direction. Moreover, the focal length of the optical adjusting device 140 can be dynamically changed and the focus position of the image IMG can be correspondingly adjusted via the optical adjusting device 140 according to the electrical signal SIN2 to render a three-dimensional virtual image IMG. In another embodiment, the image IMG can also be, for instance, imaged as a two-dimensional image, and the optical adjusting device 140 can also adjust the focus position of the image IMG according to the electrical signal SIN2 as needed. The invention does not limit the display apparatus type or the image content adapted to the function of the optical adjusting device 140 adjusting the focus position of the image IMG according to the electrical signal SIN2.

Based on the above, the embodiments of the invention have at least one of the following advantages or efficacies. In an exemplary embodiment of the invention, the image control module and the image output module are connected by an optical fiber, and an optical adjusting device is disposed at the output terminal of the optical fiber. Therefore, the image can be projected onto the projection target via the image output module, and the focus position of the image can be adjusted via the optical adjusting device. Moreover, in an exemplary embodiment of the invention, the optical fiber can be extended in a straight line or a curved line to be connected to the image output module and the image control module. Therefore, the optical fiber can be adapted to be disposed on different head-mounted display apparatuses and have the feature of lightweight at the same time. In an exemplary embodiment of the invention, the image information output device respectively controls the light source module to output the lighting beam and controls the optical modulator to modulate the lighting beam to generate the image frame, and controls the optical adjusting device to adjust the focus position of the image by using an electrical signal. Accordingly, a more life-like display experience can be achieved in a light apparatus design.

However, the above are only preferred embodiments of the invention, and are not intended to limit the scope of implementation of the invention. That is, any simple change and modification made according to the claims and the specification of the invention resulting in the same effect is within the patent scope of the invention. Moreover, any embodiment or claim of the invention does not need to achieve all of the objects or advantages or features disclosed in the invention. Moreover, the abstract and the headings are merely used to aid in searches of patent files and are not intended to limit the scope of the claims of the invention. Moreover, terms recited in the specification or claims such as “first” and “second” are only used to name the elements or distinguish different embodiments or scopes, and are not intended to limit the maximum or minimum number of the elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A head-mounted display apparatus adapted to project an image onto a projection target, the head-mounted display apparatus comprising:
an image output module adapted to project the image onto the projection target;
an image control module electrically connected to the image output module, adapted to output a first electrical signal to the image output module, so as to control the image output module to project the image onto the projection target according to the first electrical signal, wherein the image control module is adapted to output a lighting beam to the image output module;
an optical fiber adapted to be optically coupled to the image output module and the image control module, wherein the lighting beam is transmitted from the image control module to the image output module via the optical fiber; and
an optical adjusting device disposed at an output terminal of the optical fiber and adapted to transmit the lighting beam to the image output module.

2. The head-mounted display apparatus of claim 1, wherein the optical adjusting device is adapted to output the lighting beam to the image output module in a collimated manner.

3. The head-mounted display apparatus of claim 1, wherein the optical adjusting device is adapted to adjust a focus position of the image according to a second electrical signal.

4. The head-mounted display apparatus of claim 1, wherein the optical fiber is extended in a preset direction in a straight line to be optically coupled to the image output module and the image control module.

5. The head-mounted display apparatus of claim 1, wherein the optical fiber is extended in a plurality of different directions in a curved line to be optically coupled to the image output module and the image control module.

6. The head-mounted display apparatus of claim 1, wherein the image control module comprises:
a light source module adapted to output the lighting beam to the optical fiber, wherein the lighting beam is transmitted from the light source module to the image output module via the optical fiber; and
an image information output device adapted to control the light source module to output the lighting beam and output the first electrical signal to control the image output module to project the image onto the projection target.

7. The head-mounted display apparatus of claim 6, wherein the lighting beam outputted by the light source module is monochromatic light or colored light comprising a plurality of colors.

8. The head-mounted display apparatus of claim 1, wherein the image output module comprises:
an optical modulator adapted to receive the lighting beam transmitted by the optical adjusting device and modulate the lighting beam according to the first electrical signal to generate the image frame; and
a projection device adapted to project the image onto the projection target.

9. The head-mounted display apparatus of claim 1, further comprising:
an apparatus body adapted to carry the image output module, the image control module, the optical fiber, and the optical adjusting device, wherein the image output module, the image control module, the optical fiber, and the optical adjusting device are disposed on the apparatus body in an embedded manner or by hanging externally.

10. The head-mounted display apparatus of claim 1, wherein the image is a two-dimensional image or a three-dimensional image after imaging.
